(19) United States
(12) Patent Application Publication
(10) Pub. No.: US 2026/0303641 A1
(43) Pub. Date: Oct. 1, 2026

(54) AUTOMATED VULNERABILITY INTEGRATION, PRIORITIZATION, AND VERIFICATION IN AUTONOMOUS PENTESTING

(71) Applicant: Horizon 3 AI, Inc., Dover, DE (US)

(72) Inventors: Noah King, Wake Forest, NC (US); Hanjing Cao, New York, NY (US); Justin Lloyd Cady, North Augusta, SC (US); Timothy Hoer, Ferndale, MI (US); Trampas Howe, Hancock, MN (US); Travis Fahlgren, Carthage, NC (US); Ziad El Badawi, Leander, TX (US)

(21) Appl. No.: 19/092,883

(22) Filed: Mar. 27, 2025

(51) Int. Cl. H04L 9/40; H04L 41/16; H04L 43/065

(52) U.S. Cl. CPC H04L 63/1433; H04L 41/16; H04L 43/065

(57) ABSTRACT

An autonomous pentesting service may perform first autonomous pentesting operations including collecting and storing network asset data of one or more networks. The service may receive an indication of an emerging vulnerability applicable to an application or a service. The service may identify network devices of the one or more networks associated with the application or the service based on the stored network asset data and receiving the indication of the emerging vulnerability. The service may generate confidence scores associated with an accuracy of identifying of the network devices based on a comparison between first attributes of the application or the service associated with the network devices and second attributes of the emerging vulnerability. The service may selectively perform, in accordance with the confidence scores, second autonomous pentesting operations targeting the network devices.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support automated vulnerability integration, prioritization, and verification in autonomous pentesting.

In some aspects, the techniques described herein relate to a method for integrating emerging vulnerabilities with autonomous pentesting, including: performing one or more first autonomous pentesting operations, the one or more first autonomous pentesting operations including collecting and storing network asset data of one or more networks; receiving an indication of an emerging vulnerability applicable to an application or a service; identifying one or more network devices of the one or more networks associated with the application or the service based at least in part on the stored network asset data and receiving the indication of the emerging vulnerability; generating one or more confidence scores associated with an accuracy of identifying of the one or more network devices based at least in part on a comparison between one or more first attributes of the application or the service associated with the one or more network devices and one or more second attributes of the emerging vulnerability; and selectively performing, in accordance with the one or more confidence scores, one or more second autonomous pentesting operations targeting the one or more network devices.

In some aspects, the techniques described herein relate to an apparatus for compromising cookies via autonomous pentesting, including: one or more memories storing processor-executable code; and one or more processors coupled with the one or more memories and individually or collectively operable to execute the code to cause the apparatus to: perform one or more first autonomous pentesting operations, the one or more first autonomous pentesting operations including collecting and storing network asset data of one or more networks; receive an indication of an emerging vulnerability applicable to an application or a service; identify one or more network devices of the one or more networks associated with the application or the service based at least in part on the stored network asset data and receiving the indication of the emerging vulnerability; generate one or more confidence scores associated with an accuracy of identifying of the one or more network devices based at least in part on a comparison between one or more first attributes of the application or the service associated with the one or more network devices and one or more second attributes of the emerging vulnerability; and selectively perform, in accordance with the one or more confidence scores, one or more second autonomous pentesting operations targeting the one or more network devices.

In some aspects, the techniques described herein relate to a non-transitory computer-readable medium storing code for compromising cookies via autonomous pentesting, the code including instructions executable by one or more processors to: perform one or more first autonomous pentesting operations, the one or more first autonomous pentesting operations including collecting and storing network asset data of one or more networks; receive an indication of an emerging vulnerability applicable to an application or a service; identify one or more network devices of the one or more networks associated with the application or the service based at least in part on the stored network asset data and receiving the indication of the emerging vulnerability; generate one or more confidence scores associated with an accuracy of identifying of the one or more network devices based at least in part on a comparison between one or more first attributes of the application or the service associated with the one or more network devices and one or more second attributes of the emerging vulnerability; and selectively perform, in accordance with the one or more confidence scores, one or more second autonomous pentesting operations targeting the one or more network devices.

### BRIEF DESCRIPTION OF THE DRAWINGS

FIG. 1 shows an example of a computing environment that supports automated vulnerability integration, prioritization, and verification in autonomous pentesting in accordance with aspects of the present disclosure.

FIG. 2 shows an example of an autonomous pentest map that supports automated vulnerability integration, prioritization, and verification in autonomous pentesting in accordance with aspects of the present disclosure.

FIG. 3 shows an example of a computing environment that supports automated vulnerability integration, prioritization, and verification in autonomous pentesting in accordance with aspects of the present disclosure.

FIG. 4 shows an example of a computing environment that supports automated vulnerability integration, prioritization, and verification in autonomous pentesting in accordance with aspects of the present disclosure.

FIG. 5 shows an example of an emerging vulnerability flow that supports in accordance with aspects of the present disclosure.

FIG. 6 shows an example of a user interface that supports automated vulnerability integration, prioritization, and verification in autonomous pentesting in accordance with aspects of the present disclosure.

FIG. 7 shows a diagram of a system including a device that supports automated vulnerability integration, prioritization, and verification in autonomous pentesting in accordance with aspects of the present disclosure.

FIG. 8 shows a flowchart illustrating methods that support automated vulnerability integration, prioritization, and verification in autonomous pentesting in accordance with aspects of the present disclosure.

### DETAILED DESCRIPTION

A security team may manually monitor for, analyze, and develop remediations for emerging vulnerabilities. For example, a member of a security team (e.g., an attack team, offensive security professionals, a red team, threat hunters, etc.) may monitor news sources, common vulnerabilities and exposures (CVE) databases, vendor documentation, or the like for reports of emerging weaknesses, such as vulnerabilities. As used herein, a vulnerability may refer to a CVE having a unique identifier and accessible on a public database, a publicly disclosed vulnerability that is not yet recorded as a CVE, or a vulnerability discovered via pentesting that has not yet been publicly disclosed (e.g., a zero-day vulnerability). Security teams may evaluate whether emerging vulnerabilities have a relatively high risk of being exploited and, if so, develop patches for such vulnerabilities. Though tens of thousands of vulnerabilities emerge each year, only a small percentage are exploited because attackers may prioritize vulnerabilities that are relatively easy to exploit, present across a large number of networks, or have a high potential impact. Additionally, attackers may execute exploitations for vulnerabilities relatively quickly (e.g., within days) after disclosure of the vulnerabilities. In such cases, security teams may be expected to quickly identify which vulnerabilities have risk of exploitation and preventatively develop and implement remediation measures. However, this process may involve manual effort and human expertise, including manual review and evaluation of emerging vulnerabilities and development of remediation measures. As vulnerabilities emerge more quickly and networks managed by security teams become more varied, security teams may lack resources to manually review and prevent exploitation of emerging vulnerabilities.

Techniques described herein relate to implementing an agentic workflow that utilizes network asset data obtained via autonomous pentesting to improve management of emerging vulnerabilities. An autonomous pentesting service may receive an indication of an emerging vulnerability and identify, from stored network asset data obtained via autonomous pentesting, network devices having an application or service associated with the emerging vulnerability. After identifying potentially vulnerable network devices, the autonomous pentesting service may generate confidence scores associated with an accuracy of identifying the network devices as having the emerging vulnerability. Additionally, or alternatively, the autonomous pentesting service may generate risk scores indicative of how likely the emerging vulnerability is to be exploited, how impactful exploitation of the emerging vulnerability would be, or both. Based on the confidence scores and/or the risk scores, the autonomous pentesting service may selectively perform autonomous pentesting operations targeting potentially vulnerable network devices.

In some examples, the autonomous pentesting service may implement one or more large language models (LLMs) to perform one or more operations described herein. For example, the autonomous pentesting service may use LLMs to augment information about emerging vulnerabilities, generate queries for data stores to identify network devices having an application or service to which the emerging vulnerabilities are applicable, generate exploits that test emerging vulnerabilities (e.g., generate autonomous pentesting operations), and the like. By using the LLMs to perform one or more operations described herein, the autonomous pentesting service may manage emerging vulnerabilities with efficiency and across a large scope of network assets that a human security team may not be capable of manually monitoring or managing.

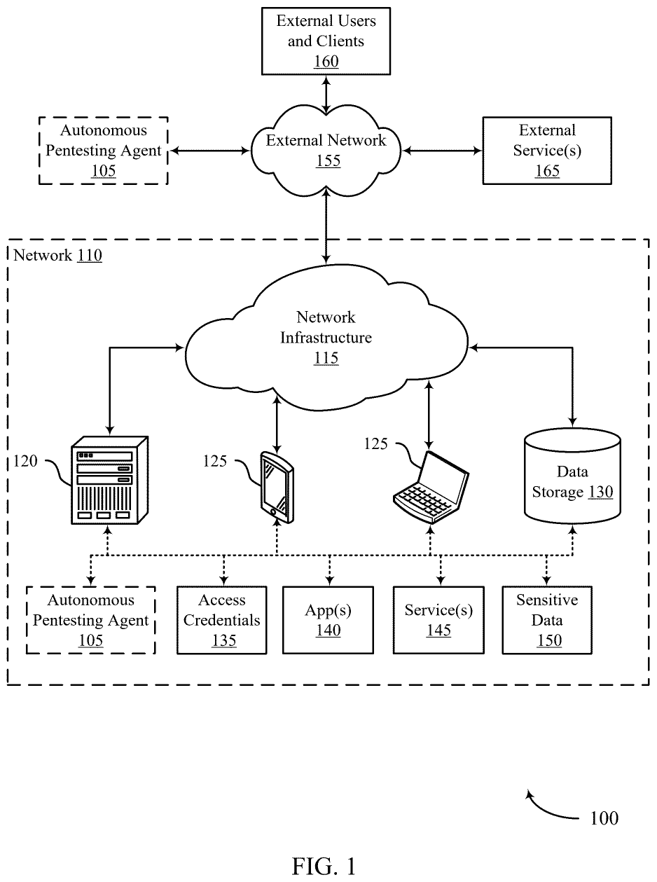

FIG. 1 illustrates an example of a computing environment 100 that supports in accordance with aspects of the present disclosure. The computing environment 100 may include an autonomous pentesting agent 105 that performs an autonomous pentest of a network 110. The network 110 may include one or more devices or systems, such as a network infrastructure 115, server 120, computing devices 125, data storage 130, or any combination thereof. The devices or systems of the network 110 may be configured to access or provide various network information and services, such as access credentials 135, app(s) 140, service(s) 145, sensitive data 150, or any combination thereof.

The network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the network 110 as well as communication between the network 110 (e.g., the private network) and an external network 155 (e.g., the Internet). The network 110 may include aspects of one or more wired networks, one or more wireless networks (e.g., cellular networks), or any combination thereof. The network 110 may include aspects of one or more public networks or private networks, as well as secured or unsecured networks, or any combination thereof. For example, the network 110 may be an example of a private network that includes one or more public-facing or external assets that are accessible via an external network 155. As an example, the external network 155 may refer to the Internet, and users, such as external users and clients 160, may access the network 110 via the external network 155 through a website or application that is on the external network 155. For example, the external users and clients 160, the external service(s) 165, or both may access network information and services via the external network 155 (e.g., via the Internet), including the access credentials 135, app(s) 140, service(s) 145, and sensitive data 150.

The network 110 may be accessible via one or more hosts. For example, hosts may be examples of real or virtual machines that are connected to and capable of accessing the network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the network 110 and outside of the network (e.g., with devices in an external network 155). For example, the server 120 may send data to and receive data from one or more of the computing devices 125. Additionally, or alternatively, hosts may access resources of the network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein, network assets refer to data, devices, or components of the network 110, including software and hardware. In some examples, network assets may refer to machines that include network shares. For example, network assets may be examples of machines (e.g., real or virtual machines) that include shares of the network 110, such as file sharing systems. Network assets may be obtained and utilized by attackers to compromise the network 110. In some cases, network assets may refer to network entities (i.e., system hosts/machines) that have internet protocol (IP) addresses and may be discovered during scans. The server 120, the computing devices 125 (e.g., laptops, desktops, and mobile devices, smart vehicles, wearables, etc.), the data storage 130, and the access credentials 135, app(s) 140, service(s) 145, cookies, encryption and decryption keys, tokens, and sensitive data 150 accessible via the devices and systems of the network 110 may all be examples of network assets. Other examples of network assets include virtual machines, printers, Internet-of-Things (IoT) devices, switches, routers, access points, endpoints, public static IPs, Lambdas and serverless architectures, Amazon Web Service (AWS) containers, and Kubernetes pods and other containerized applications. For example, physical devices (e.g., servers, computing devices, data storage, etc.) and systems may be considered network assets as well as information, apps, and services accessible through physical devices and systems of the network 110.

Hosts may store, provide, or implement access credentials 135, app(s) 140, service(s) 145, sensitive data 150, or any combination thereof. In some cases, computing devices 125 on the network may access the one or more assets (e.g., access credentials 135, app(s) 140, service(s) 145, sensitive data 150, etc.) via the server 120 (e.g., via a host). Additionally, or alternatively, computing devices 125 may locally store or otherwise access the one or more assets of the network 110. For example, users of the network 110 may access app(s) 140 and service(s) 145 via the computing devices 125 directly or indirectly (e.g., via a connection between the computing devices 125 and the server 120).

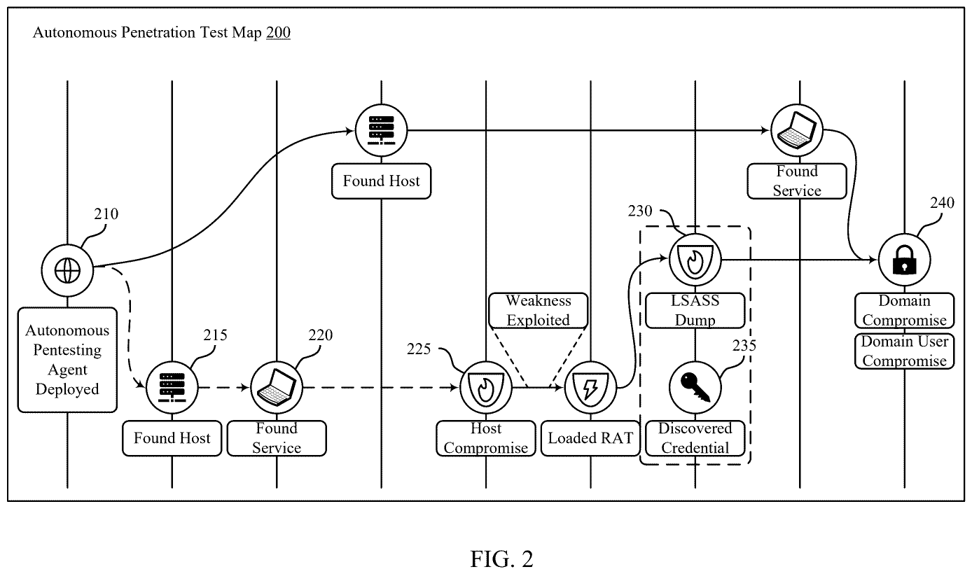

The autonomous pentesting agent 105 may perform a pentest of the network 110. As used herein, a penetration test or a “pentest” may refer to one or more security operations that simulate a cybersecurity attack in order to identify vulnerabilities in the network 110. The autonomous pentesting agent 105 may perform the pentest of the network 110 using one or more artificial intelligence (AI) models. For example, the autonomous pentesting agent 105 may be “autonomous,” as the autonomous pentesting agent 105 may perform the pentest without a requirement of hard-coding, user inputs, or the like and, instead, by using the one or more AI models. The autonomous pentesting agent 105 may identify, via the pentest, security vulnerabilities of the network 110. An example of an output of the pentest may be described in greater detail elsewhere herein, including with reference to FIG. 2.

The autonomous pentesting agent 105 may, via the one or more AI models, determine and implement an attack path for a pentest. For example, the autonomous pentesting agent 105 may identify or select an asset of the network 110 to attempt to access initially and, from that asset, another asset to attempt to access, and so on. In other words, the autonomous pentesting agent 105 may use the one or more AI models to mimic decisions of an attacker. The one or more AI models may output a targeted asset of the network 110 to be subject to an access attempt by the autonomous pentesting agent 105 based on inputs including context of various assets in the network 110. In other words, the one or more AI models may output targeted assets based on the relative position of assets within the network 110, asset types, downstream assets (e.g., accessible after or through accessing a targeted asset), or the like.

The one or more AI models may be trained using data of previous pentests of the network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the network 110 previously or on other networks, or both. The autonomous pentesting agent 105 may perform improved pentests after the one or more AI models are trained using previous pentests of the network 110. That is, as the autonomous pentesting agent 105 learns more about the network 110, the autonomous pentesting agent 105 may perform pentests with higher performance levels (e.g., higher accuracy, higher quantities of potential attack paths, etc.).

In some cases, the pentest may be internal or external to the network 110. For example, the autonomous pentesting agent 105 may be deployed at a host device of the network 110 (e.g., deployed to the server 120 or computing devices 125). In such examples, the autonomous pentesting agent 105 may perform the pentest as an internal user of the network 110. Such internal pentests may be indicative of or emulate internal security threats to the network, such as from employees of an organization or an attacker that has otherwise obtained access to the network 110 internally. Alternatively, the autonomous pentesting agent 105 may be deployed at the external network 155. For example, the autonomous pentesting agent 105 may perform the pentest as an external user of the network 110, such as by accessing external or public-facing assets of the network 110 on the external network 155. In some examples, the autonomous pentesting agent 105 may be deployed via a runner. For example, a runner may be an executable process, script, or sequence, that enables automated deployment of a container (e.g., a Docker container). A container may refer to an executable package of software including code, runtime, system tools, system libraries, settings, and other components to run an application. The runner and the container may allow a user to provision and deploy pentests from a portal without manually running a launch script for the autonomous pentesting agent 105.

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the network 110 against cybersecurity attacks relative to hard-coded (e.g., automated) or manual (e.g., human operated) pentests.

As described herein, the autonomous pentesting agent 105 may support integration with an agentic workflow to support management of emerging vulnerabilities. For example, the autonomous pentesting agent 105 may perform autonomous pentesting operations targeting network devices that may be exploitable via an emerging vulnerability. The autonomous pentesting agent 105 may perform the autonomous pentesting operations based on confidence scores associated with an accuracy of identifying the network devices as having the emerging vulnerability, risk scores of the emerging vulnerability, or both.

Techniques described herein may improve one or more aspects of an autonomous pentesting service that includes the autonomous pentesting agent 105. For example, the autonomous pentesting service may support improved scalability and speed. That is, by implementing the agentic workflow described herein, the autonomous pentesting service may reduce a manual workload of a security team, allowing the security team to manage a larger volume of vulnerabilities and network assets. For example, as variation in network assets increases, security teams may not be able to effectively track which networks have assets that may be vulnerable to emerging vulnerabilities. In other words, networks may have large attack surfaces (e.g., thousands of network assets), and there may be emerging vulnerabilities that threaten attack surfaces daily. It may be difficult to manually manage, triage, and remediate all emerging vulnerabilities for such large attack surfaces. Additionally, access to relevant information to identify vulnerabilities may be located throughout many information sources, which may make it difficult for a human to manage emerging vulnerabilities. Accordingly, implementation of the agentic workflow may enable security teams to monitor the effect of emerging vulnerabilities across a variety of networks and network assets. That is, the agentic workflow may enable asset tracking, dynamic querying based on emerging vulnerabilities, mitigating and/or remediating for emerging vulnerabilities, and reporting of these operations for human review, which may enable security teams to sift through higher volumes of emerging vulnerabilities.

Additionally, the agentic workflow may enable security teams to respond to emerging vulnerabilities more quickly based on autonomous querying, proactive alerts, and immediate implementation of security mitigations for high-risk vulnerabilities. For example, the techniques described herein support dynamic customer alerts as emerging vulnerabilities are analyzed, which may support faster mitigation implementation (e.g., notifying users to isolate vulnerable network assets, implement remediation operations, etc.). Because emerging vulnerabilities may be exploited relatively quickly after emergence (e.g., within 48 hours), enabling security teams to respond more quickly by using the agentic workflow may prevent exploitation of emerging vulnerabilities. In some aspects, one or more LLMs of the agentic workflow may support continuous improvement by refining predictions and assessments over time based on historical data and new threat intelligence.

FIG. 2 shows an example of an autonomous pentest map 200 that supports in accordance with aspects of the present disclosure. The autonomous pentest map 200 may be an example of an output or result of an autonomous pentest performed by an autonomous pentesting agent, such as a pentest performed by the autonomous pentesting agent 105 in the network 110 as described with reference to FIG. 1. The autonomous pentest map 200 may illustrate and describe an example of events of a pentest, including operations performed by and information obtained by the autonomous pentesting agent. The autonomous pentest map 200 in the example of FIG. 2 may illustrate a map after completion of a pentest, but in some examples, the autonomous pentesting service may display and update the autonomous pentest map 200 during a pentest as events occur. For example, the autonomous pentesting service may display a real-time view that provides real-time information and updates on the progress of a currently running pentest, including status updates for injected credentials.

The autonomous pentest map 200 may include one or more types of events. In some examples, the autonomous pentest map 200 may illustrate notable events, which may be events that did or would likely (e.g., in a real-time view) lead to a critical impact. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). An attacker tool 230, such as a RAT, may refer to software that enables full control of a tech device remotely. RATs may have legitimate uses, such as technical support, but may also be controlled by attackers with malicious intent. In the context of the autonomous pentesting agent, a RAT may be used to provide the autonomous pentesting agent with additional access to further explore attack paths during operations.

The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. In other words, an attack path may refer to the sequence of steps or actions an attacker or autonomous pentesting agent 105 may take to compromise a system or network. An attack path may involve identifying vulnerabilities and other weaknesses, exploiting them, and navigating through the network 110 to access valuable information or resources. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent may perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

As used herein, a weakness may refer to a vulnerability or security flaw that may be exploited by an attacker to compromise a system or network. Weaknesses may include misconfigurations, outdated software, default credentials, or other vulnerabilities that may be leveraged to gain unauthorized access or perform malicious actions. Some vulnerabilities may be publicly known. For example, an N-day may be a software or hardware vulnerability that is already publicly known, (e.g., n days since disclosure, where n is a positive integer) but there may or may not be a security update available to remediate the vulnerability. Weaknesses, if exploited, may be associated with impacts. An impact may summarize, in business terms, the effects the autonomous pentesting agent was able to achieve as a result of exploiting weaknesses in an environment. An example of an impact may be a sensitive data exposure, which may indicate that the autonomous pentesting agent was able to potentially access sensitive information given the filetype or service that is compromised (e.g., business documents in file shares, Outlook personal storage table (PST) files, confluence remote code execution (RCE), exchange RCE, etc.).

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support pentesting that targets emerging vulnerabilities. For example, the autonomous pentesting service may verify whether network devices are capable of being exploited using emerging vulnerabilities. Additionally, the autonomous pentesting service may identify an impact of exploitation of emerging vulnerabilities in different networks. For example, the autonomous pentesting service may perform pentesting operations targeting network devices associated with an emerging vulnerability. Through an attack path of the autonomous pentesting operations, the autonomous pentesting service may identify whether and how emerging vulnerabilities may be exploited to achieve compromise events.

By identifying how emerging vulnerabilities may lead to compromise events, the autonomous pentesting service may effectively prioritize vulnerabilities for remediation efforts, alerts to users of affected networks or devices, or the like. Put another way, the autonomous pentesting service may use pentesting results (e.g., compromise events achieved via targeted pentesting operations) to allocate resources such that vulnerabilities leading to more severe compromise events are prioritized over vulnerabilities that lead to relatively less severe compromise events. As an example, the autonomous pentesting service may allocate resources for remediation operations to a vulnerability leading to full domain compromise rather than a vulnerability leading to host compromise.

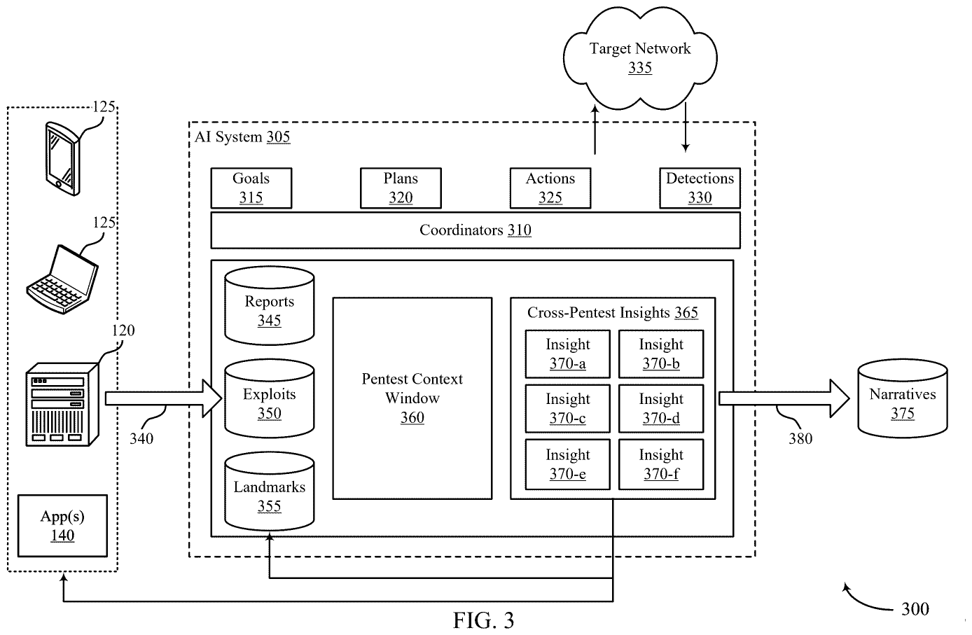

FIG. 3 shows an example of a computing environment 300 that supports in accordance with aspects of the present disclosure. The computing environment 300 may implement or be implemented by the computing environment 100, the autonomous pentest map 200, or both. For example, the computing environment 300 may illustrate servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions. In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing. In some examples, the AI system 305 may utilize an LLM which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously, at least for some operations, to achieve specified goals, make decisions, and take actions without direct human intervention (e.g., through the use of AI agents). In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a network 110, compromise (such as by obtaining unauthorized administrative access or deploying unauthorized software to) a domain or a network asset of the network 110, or any combination thereof. To obtain the goals 315, the AI system 305 may generate one or more plans 320 that are based on actions 325 and detections 330. For example, to determine a next best action within a defined set of guardrails or instructions, the AI system 305 may generate a plan 320 that can include an action 325 to invoke (e.g., execute) one or more commands on a target network 335 to obtain a detection 330 from the target network 335.

In some examples, the target network may include one or more network assets such as servers 120, computing devices 125, data storages 130, app(s) 140, or any combination thereof. Further, obtaining a detection 330 from the target network 335 may include the AI system 305 retrieving telemetry data from the one or more network assets of the target network 335. In some cases, telemetry data obtained from the target network 335 may include logs, traces, metrics, events, or any combination thereof from the one or more network assets of the target network 335. For example, a detection 330 may include some data that is obtained from the target network 335 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 335, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, or billions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 thar resulted in the action 325 succeeding or failing, or any combination thereof. Therefore, the AI system 305 may continuously obtain and update the training data used for training AI/ML models and perform reinforcement learning using collective intelligent to improve the weights and training of the AI/ML models.

In some examples, the training data for the AI system 305 may include telemetry data obtained from the target network 335, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 335) to assist the AI system 305 to navigate and map a target environment during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by proving the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 335, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may process information about ongoing pentests, including successfully exploited vulnerabilities, accessed systems and data, attempted but failed exploit paths, among others.

In some examples, the AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 370-e, and an insight 370-f). For example, the insight 370-a may indicate patterns of vulnerable default configurations in commonly used enterprise software. In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant network compromise. Therefore, the cross-pentest insights 365 may indicate one or more insights 370 that represent patterns and vulnerabilities that occur across different networks and testing scenarios, helping organizations better understand systemic security weaknesses that need to be addressed. For example, the cross-pentest insights 365 may be added as landmarks 355 for further training the AI system 305 to perform autonomous pentests.

In some examples, the cross-pentest insights 365 may be displayed to one or more computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a network 110. In another example, a narrative 375 may be a presentation for a company or organization that indicates the one or more vulnerabilities in a network 110 associated with the company or organization. For example, the presentation can indicate the cross-pentest insights 365 obtained from performing one or more autonomous pentests on the network 110 associated with the company or organization (e.g., the target network 335).

An autonomous pentesting service may utilize the AI system 305 to integrate emerging vulnerabilities with autonomous pentesting. For example, the AI system 305 may include one or more LLMs. The autonomous pentesting service may use the one or more LLMs to augment information received about emerging vulnerabilities, generate queries for customer data, generate risk and confidence scores, generate exploits, generate patches, or any combination thereof.

In some examples, the autonomous pentesting service may implement the one or more LLMs in conjunction with one or more user inputs. For example, the autonomous pentesting service may use the one or more LLMs to generate one or more outputs that are verified via user input (e.g., human verification). As an example, the autonomous pentesting service may use the LLMs to generate a risk score and an exploit for an emerging vulnerability. The autonomous pentesting service may transmit a notification of the risk score and exploit and, in response, receive approval or denial via user input to perform a pentesting operation to test the exploit. By using the AI system 305 in conjunction with user inputs, techniques described herein may support improved efficiency while still ensuring accurate assessment of emerging vulnerabilities and safety of pentesting operations.

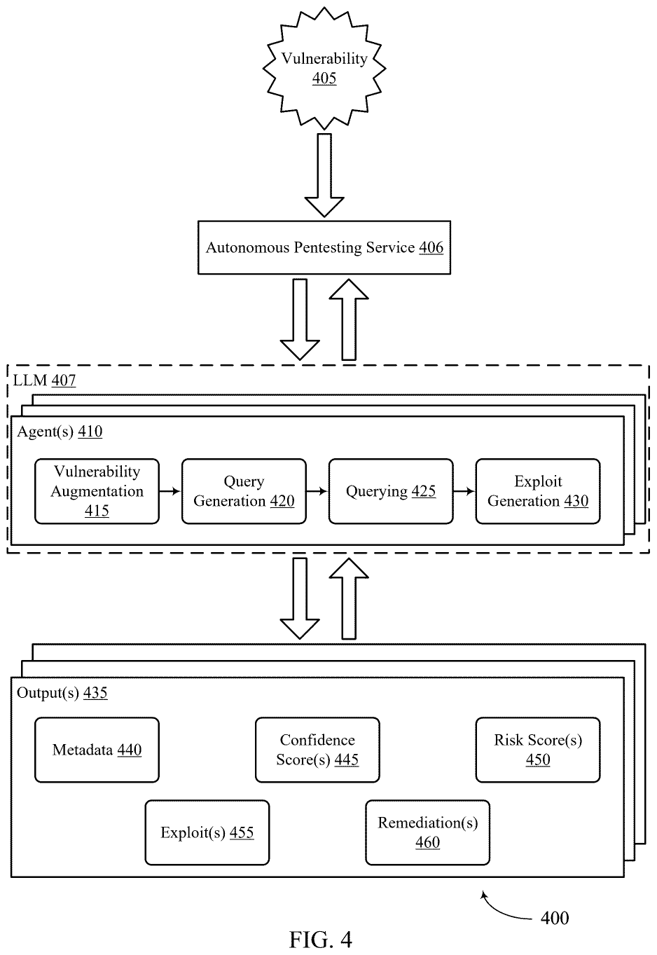

FIG. 4 shows an example of a computing environment 400 that supports in accordance with aspects of the present disclosure. The computing environment 400 may implement or be implemented by the computing environment 100, the autonomous pentest map 200, the computing environment 300, or any combination thereof. For example, the computing environment 400 may illustrate management of a vulnerability 405 by an autonomous pentesting service 406.

The autonomous pentesting service 406 may perform one or more first pentesting operations. The one or more first autonomous pentesting operations may include collecting and storing network asset data of one or more networks. For example, the autonomous pentesting service 406 may store information about network assets encountered during pentesting operations. In some examples, information about a network asset may be referred to as a fingerprint. A fingerprint may refer to a unique combination of information that identifies a system, device, or network asset. The autonomous pentesting service 406 may store the information in one or more data stores and/or as one or more data types.

The autonomous pentesting service 406 may receive an indication of a vulnerability 405 applicable to an application or a service. The vulnerability 405 may be an emerging vulnerability. As used herein, an emerging vulnerability may refer to a vulnerability not previously known to the autonomous pentesting service 406 or a vulnerability that is known but has emerging relevance. Put another way, an emerging vulnerability may be a newly announced vulnerability (e.g., publicly disclosed within the past 24 hours or another defined time period) or a previously known vulnerability associated with newly announced information, such as a new exploit. For example, the Cybersecurity & Infrastructure Security Agency (CISA) may update a database with known exploited vulnerabilities (KEVs), which may relate to vulnerabilities publicly disclosed previously (e.g., years or months ago). That is, a vulnerability may have emerging relevance based on a new KEV being added to a CISA database. The autonomous pentesting service 406 may receive the indication of the vulnerability 405 by continuously monitoring one or more information sources, such as threat intelligence feeds (e.g., GitHub, social media feeds, etc.), vulnerability databases (e.g., a CISA KEV), and internal security logs (e.g., autonomous pentest logs).

The autonomous pentesting service 406 may use agent(s) 410 of an LLM 407 to perform one or more operations herein. Agent(s) 410 may be examples of LLM agents or components of an AI model, such as the LLM 407. In some examples, the LLM 407 may be associated with the autonomous pentesting service 406 or external to the autonomous pentesting service 406. That is, communications between the autonomous pentesting service 406 and the LLM 407 may be internal or external. The agent(s) 410 may perform vulnerability augmentation 415. For example, the agent(s) 410 may combine information about the vulnerability 405 from multiple information sources. Augmenting the vulnerability 405 may fill in gaps and build a more detailed fingerprint (e.g., unique identity) of the vulnerability 405, allowing the autonomous pentesting service 406 to more accurately assess risk, identify vulnerable network assets, and generate remediation operations (e.g., fix actions).

The autonomous pentesting service 406 may analyze the vulnerability 405 and output risk score(s) 450 based on the augmented vulnerability. For example, the autonomous pentesting service 406, via the agent(s) 410, may correlate the vulnerability 405 with historical data, prior exploit patterns, or the like. In some examples, the autonomous pentesting service 406 may extract attributes of the vulnerability 405 (e.g., the augmented vulnerability) to generate an initial risk score (e.g., prior to query generation 420 and/or querying 425). That is, the agent(s) 410 may extract and compare attributes of the vulnerability 405 to attributes of vulnerabilities previously exploited. Accordingly, the agent(s) 410 may generate an initial prediction of whether the vulnerability 405 poses a relatively high or low risk of being exploited and/or leading to compromise event(s). The agent(s) 410 may determine whether the vulnerability 405 is high-risk based on attack likelihood, affected network assets, and potential impact of compromise on those network assets. As an example, the agent(s) 410 may target network assets that are internet-facing, which are most easily accessible by attackers. In such examples, the agent(s) 410 may receive some inputs or be trained to identify vulnerabilities pertaining to internet-facing (e.g., external) assets as being higher risk than internal assets. That is, the agent(s) 410 may receive an input to assign emerging vulnerabilities applicable to externally facing network assets a higher risk level than emerging vulnerabilities applicable to internally facing network assets.

In some examples, the agent(s) 410 may identify the vulnerability 405 as having an initial risk score below a threshold. For example, the agent(s) 410 may determine that an exploit of the vulnerability is not likely, the vulnerability is unlikely to lead to a compromise event, the vulnerability is applicable to a relatively rare application or service, or any combination thereof. In such examples, the agent(s) 410 may refrain from proceeding to analyze the vulnerability 405. Additionally, or alternatively, the agent(s) 410 may prioritize the vulnerability 405 within a queue of emerging vulnerabilities based on the initial risk score. For example, agent(s) 410 may, after generating the initial risk score, insert the vulnerability 405 within a queue for query generation 420 (e.g., the next operation of the workflow), where the queue is ordered from highest risk score to lowest risk score. Put another way, the autonomous pentesting system may adjust prioritization dynamically based on real-time threat developments, ensuring security teams focus on the most critical vulnerabilities first.

The agent(s) 410 may perform query generation 420 and querying 425 based on the augmented vulnerability. For example, the agent(s) 410 may generate queries that scan internal and external asset databases for exposure to the vulnerability 405. As an example, if the vulnerability 405 is related to Fortinet, the agent(s) 410 may generate queries to collect information about network assets from a database (e.g., of the LLM 407) to determine whether network assets have Fortinet and may have the vulnerability 405. That is, the autonomous pentesting service 406 may leverage network asset data (e.g., fingerprinted assets) obtained through autonomous pentesting to evaluate whether network assets may be susceptible to the vulnerability 405. Put another way, the autonomous pentesting service 406 may identify one or more network devices of one or more networks associated with an application or a service associated with the vulnerability 405 based on stored network asset data and receiving the indication of the vulnerability 405.

The agent(s) 410 may perform exploit generation 430 based on the querying 425. For example, the agent(s) 410 may output exploit(s) 455 (e.g., executable code, chains of autonomous pentesting operations, etc.) that use the vulnerability 405 to achieve compromise event(s). Put another way, the agent(s) 410 may generate one or more autonomous pentesting operations based on identifying one or more network devices and the indication of the vulnerability 405, where the one or more autonomous pentesting operations verify whether the emerging vulnerability is exploitable at the one or more network devices. The agent(s) 410 may develop the exploit(s) 455 based on scanning repositories, feeds, and the Internet. Exploit(s) 455 may be written in YAML, Python, or Ruby and/or be integrated into the autonomous pentesting service 406. If executed during an autonomous pentest, the exploit(s) 455 may prove that the vulnerability 405 is exploitable.

In some examples, the autonomous pentesting service 406 may transmit an indication of the exploit(s) 455 for authorization via user input. A human, by providing a user input, may verify that the exploit(s) 455 output from the agent(s) 410 are valid and safe to use during pentesting. Put another way, the autonomous pentesting service 406 may receive, prior to selectively executing the one or more autonomous pentesting operations (e.g., the exploits during pentesting), a user input authorizing performing the one or more autonomous pentesting operations.

The autonomous pentesting service 406 may update the initial risk score based on one or more operations described herein. For example, the risk assessment (e.g., generation of risk score(s) 450), the querying 425, and the exploit generation 430 may be circular. That is, the agent(s) 410 may go back-and-forth between evaluation of whether to pursue the vulnerability 405 (e.g., whether to transmit notifications of the vulnerability 405 to users, implement remediation operations, etc.), the querying 425 of stored network asset data, and the exploit generation 430 to output a decision about whether to perform autonomous pentesting operations that target the vulnerability 405. As an example, the agent(s) 410 may update the vulnerability 405 to have a high risk score based on determining that one or more network devices are associated with (e.g., run, are installed with, use via the Internet, etc.) an application or service affected by the vulnerability 405 and that the vulnerability 405 is exploitable (e.g., based on the exploit generation 430). In other words, the autonomous pentesting service 406 may determine one or more risk levels of exposure of one or more network devices to the vulnerability 405 based on an attack probability (e.g., information prior to querying 425), a quantity or priority level of the one or more network devices, a projected impact of compromise on the one or more network devices, or any combination thereof.

The autonomous pentesting service 406 may generate confidence score(s) 445 associated with an accuracy of identifying of the one or more network devices. In other words, the autonomous pentesting service 406 may generate a confidence score for the vulnerability 405 that indicates how accurate identification of potentially vulnerable assets is. The autonomous pentesting service 406 may generate the confidence score(s) 445 based on a comparison between one or more first attributes of the application or the service associated with the one or more network devices and one or more second attributes of the vulnerability 405. In some aspects, confidence score(s) 445 may be based on matches between attributes of the network devices and the vulnerability 405. As an example, a network device may have a configuration or settings enabled on the app or service to which the vulnerability 405 is applicable. The agent(s) 410 may predict, based on the vulnerability augmentation 415, that the vulnerability 405 is applicable to the app or service when the app or service has a given configuration or settings enabled (and/or whether the vulnerable configuration is a common one based on public information). Accordingly, the agent(s) 410 may compare the configuration or settings on the network device to the predicted configuration or settings associated with the vulnerability 405. The comparison may produce a confidence score (e.g., a similarity score) between attributes of the network device and the vulnerability 405 and, if the confidence score exceeds a threshold, may trigger other operations (e.g., alerting, pentesting, etc.). The confidence score(s) 445 may be derived from multiple factors, including exploitability likelihood, available intelligence, strength or accuracy of information about the vulnerability 405 (e.g., strength or accuracy of a fingerprint of the vulnerability 405), asset exposure data, and current and previous pentesting data (e.g., if a network asset appears in current or previous pentests). For example, absence of a network asset that may be affected by a vulnerability in a pentest may not suggest that the network asset is not vulnerable. Accordingly, in such examples, the confidence score(s) 445 may be based on previous pentesting information. In some examples, the factors may be weighted in accordance with contribution to exploiting the vulnerability. For example, factors like asset exposure—whether a network asset is available via the Internet (e.g., externally) or not—may be weighted higher than other factors.

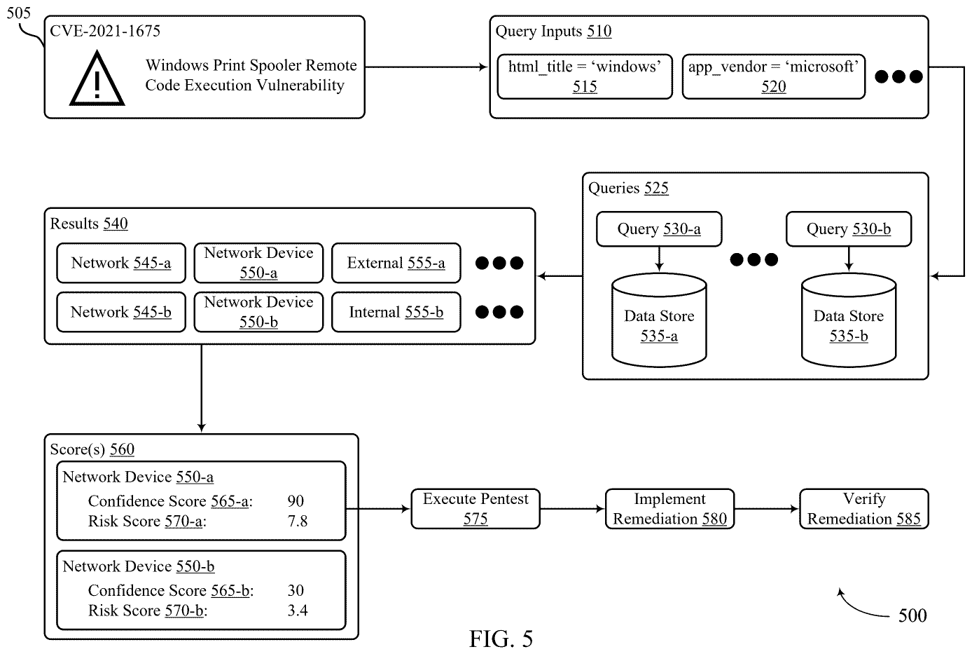

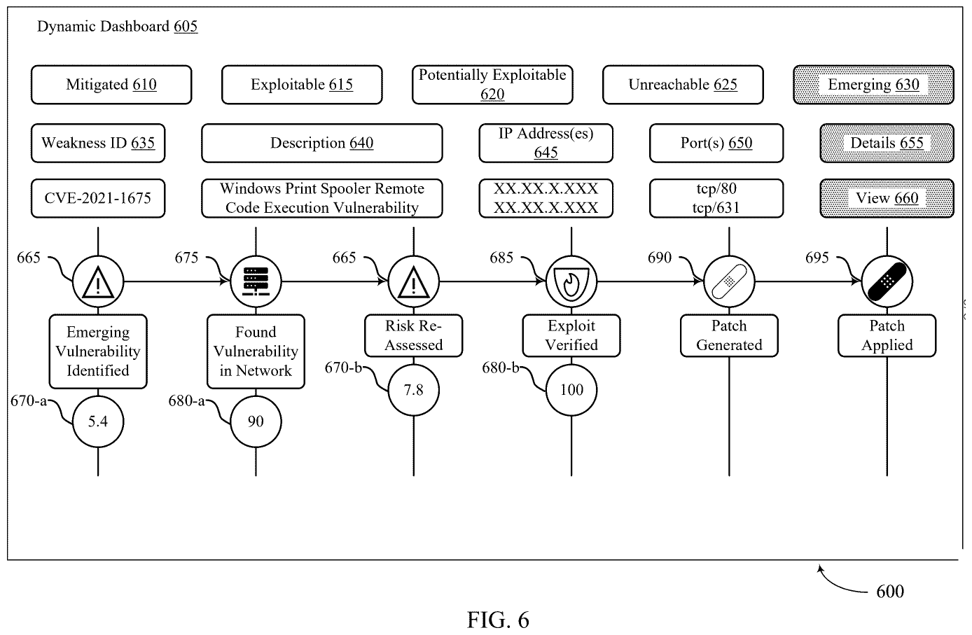

The agent(s) 410 may generate output(s) 435 based on the vulnerability augmentation 415, the query generation 420, the querying 425, and the exploit generation 430. The output(s) 435 may include metadata 440, confidence score(s) 445, risk score(s) 450, exploit(s) 455, and remediation(s) 460. The output(s) 435 may include parameters output at various instances during the vulnerability augmentation 415, the query generation 420, the querying 425, and the exploit generation 430. Additionally, the operations performed by the agent(s) 410 may produce metadata 440 (e.g., static data about the vulnerability 405, fix actions, proof of concept exploits) associated with the vulnerability 405, exploits, and potential patches that can be used for pentesting and/or remediation. The output(s) 435 may be used to determine whether to pursue pentesting and/or remediation operations. Pentesting and remediation operations based on the output(s) 435 may be described in greater detail elsewhere herein, including with reference to FIG. 5. Additionally, or alternatively, output(s) 435 may feed into alerts and dashboard information about potentially vulnerable assets. Alerting and the dashboard may be described in further detail elsewhere herein, including with reference to FIG. 6.

The autonomous pentesting service 406 may continuously monitor emerging exploit techniques and attack methodologies tied to known vulnerabilities. For example, after generating the output(s) 435 associated with the vulnerability 405, the autonomous pentesting service 406 may continue to monitor multiple information sources for emerging information about the vulnerability 405 that may trigger the vulnerability 405 to be reassessed. As an example, if a new exploit is detected for a previously assessed vulnerability, the agent(s) 410 may reassess the vulnerability and may notify affected networks via updated alerts with revised risk assessments.

Additionally, or alternatively, the autonomous pentesting service 406 may continuously train the LLM 407. For example, the autonomous pentesting service 406 may refine its detection, alerting, and pentesting processes based on previous security incidents (e.g., trains the LLM 407 to better identify high risk vulnerabilities and develop patches over time). The autonomous pentesting service 406 may train the LLM 407 using various information associated with network assets, such as Hypertext Markup Language (HTML) source code, server response headers, open ports, exposed application programming interface (API) endpoints, or any other information that can be gained based on scanning a host. Additionally, or alternatively, training data may include asset metadata such as tags indicating criticality of assets, scoring data (e.g., digital rubrics for determining risk and/or confidence scores), or the like. In some aspects, the autonomous pentesting service 406 may store information associated with one or more recommended remediation operations. The autonomous pentesting service 406 may selectively execute autonomous pentesting operations in the future (e.g., after selectively pentesting for the vulnerability 405) in accordance with another emerging vulnerability based on the stored information associated with the one or more recommended remediation operations.

FIG. 5 shows an example of an emerging vulnerability flow 500 that supports in accordance with aspects of the present disclosure. The emerging vulnerability flow 500 may implement or be implemented by the computing environment 100, the autonomous pentest map 200, the computing environment 300, the computing environment 400, or any combination thereof. For example, the emerging vulnerability flow 500 may illustrate one or more operations performed in accordance with emergence of a CVE 505.

An autonomous pentesting service may, via continuous monitoring using one or more LLMs, identify the CVE 505. In the example of FIG. 5, the CVE 505 may be CVE-2021-1675, a Windows print spooler RCE vulnerability otherwise known as “PrinterNightmare.” Based on the CVE 505 (e.g., and, optionally, augmentations to information about the CVE 505), the autonomous pentesting service may generate query inputs 510. The query inputs 510 may include a HTML title 515 and an application vendor 520, among other examples.

Using the query inputs 510, the autonomous pentesting service (e.g., using one or more LLMs) may scan various sources (e.g., for key terms associated with the CVE 505, such as file names) and generate multiple different queries using the query inputs 510. For example, the autonomous pentesting service may generate a query 530-a for a data store 535-a and a query 530-b for a data store 535-b. The autonomous pentesting service may generate the queries 525 for different data stores (e.g., different formats) leveraging attributes of the CVE 505, such as a file name format corresponding to the CVE 505. An example of a query is as follows:
SELECT DISTINCT
   w.op_id AS op_id,
   w.uuid AS web_share_tab_url_uuid,
   w.url,
   w.url_path,
   w.title,
   w.response_headers
FROM
   web_share_tab_url w
WHERE
   w.title LIKE ‘%{html_title}%’

The query may scan a data store to retrieve (e.g., identify) network devices having apps or services with parameters matching the query inputs 510. For example, the query may scan for assets having titles like the input HTML title 515.

The autonomous pentesting service (e.g., using one or more LLMs) may run the queries 525 and output results 540 indicating what networks are potentially vulnerable, what assets from those customers are vulnerable, where the exploit originated (e.g., a URL), or the like. For example, the queries 525 may generate results 540 including a network 545-a having a network device 550-a that is an external 555-a asset potentially vulnerable to the CVE 505. Additionally, the results 540 may include a network 545-b having a network device 550-b that is an internal 555-b asset potentially vulnerable to the CVE 505.

The autonomous pentesting service (e.g., using one or more LLMs) may output the results 540 with associated confidence scores and/or risk scores. For example, the autonomous pentesting service may generate score(s) 560 associated with the results 540. The score(s) 560 may include a confidence score 565-a of 90 and a risk score 570-a of 7.8 for the network device 550-a as well as a confidence score 565-b of 30 and a risk score 570-b of 3.4 for the network device 550-b. The autonomous pentesting service may score the network device 550-b as being less vulnerable to the CVE 505 based on the network device 550-b being an internal 555-b asset, whereas the network device 550-a is an external 555-a asset.

As part of the output, the autonomous pentesting service (e.g., using one or more LLMs) may also identify exploits or proof of concepts (PoCs) to use for a pentest 575 that proves that the CVE 505 is exploitable at the network device 550-a. The autonomous pentesting service, via one or more autonomous pentesting agents, may run executable code of the exploits for the pentest 575. For example, the autonomous pentesting service (e.g., using an autonomous pentesting agent, such as the autonomous pentesting agent 105) may selectively perform, in accordance with the confidence scores (and/or risk scores), one or more autonomous pentesting operations targeting one or more network devices (e.g., targeting devices potentially vulnerable to the CVE 505). As an example, the autonomous pentesting service may perform autonomous pentesting operations for network devices having confidence scores, risk scores, or both above a threshold.

In some examples, the autonomous pentesting service may update an output to reflect that the CVE 505 is exploitable. The autonomous pentesting service may also automatically implement remediation 580 (e.g., a patch or fix actions) for the CVE 505, such as based on a vendor advisory, remediation(s) generated via the one or more LLMs, or the like. In some examples, implementing the remediation 580 may include applying patches, modifying vulnerable configurations, or deploying network segmentation strategies. After implementing the remediation 580, the autonomous pentesting service may verify the remediation 585, such as by executing another pentest that targets the network device 550-a. Put another way, the autonomous pentesting service may verify implementation of the one or more recommended remediation operations via one or more second autonomous pentesting operations (e.g., after the pentest 575). The autonomous pentesting service may issue one or more follow-up notifications if an incomplete or ineffective remediation is detected, ensuring vulnerabilities are fully addressed.

FIG. 6 shows an example of a user interface 600 that supports automated vulnerability integration, prioritization, and verification in autonomous pentesting in accordance with aspects of the present disclosure. The user interface 600 may implement or be implemented by the computing environment 100, the autonomous pentest map 200, the computing environment 300, the computing environment 400, the emerging vulnerability flow 500, or any combination thereof. For example, the user interface 600 may illustrate a dynamic dashboard 605 of an autonomous pentesting service.

The autonomous pentesting service may display the dynamic dashboard 605 via a user interface. The dynamic dashboard 605 may include viewing options for different statuses of weaknesses, including mitigated 610, exploitable 615, potentially exploitable 620, unreachable 625, and emerging 630. The emerging 630 weaknesses may include emerging vulnerabilities that have not yet been categorized by the autonomous pentesting service. As an example, the autonomous pentesting service may categorize an emerging vulnerability into exploitable 615 if an exploit is identified for the emerging vulnerability, mitigated 610 if a patch is implemented and/or verified, and so on. In the example of FIG. 6, the emerging 630 vulnerabilities may be selected to view in the dynamic dashboard 605.

Information about the emerging vulnerabilities displayed via the dynamic dashboard 605 may include a weakness ID 635, description 640, IP address(es) 645, port(s) 650, and details 655. The dynamic dashboard 605 may display details 655 for a vulnerability based on selection of an option to view 660 in a row of a vulnerability. An example of one vulnerability and associated information is shown with respect to FIG. 6, but it may be understood that the dynamic dashboard 605 may include similar information for any quantity of emerging vulnerabilities.

The details 655 for a vulnerability may include progress of assessment and/or mitigation of a vulnerability. That is, the autonomous pentesting service may update the dynamic dashboard 605 in real-time as the vulnerability is managed (e.g., according to the operations described with reference to FIGS. 4 and 5, as an example). For example, the autonomous pentesting service may dynamically update a user interface with information associated with an emerging vulnerability based on receiving an indication of the emerging vulnerability, identifying one or more network devices (e.g., potentially vulnerable network devices), generating one or more confidence scores, selectively performing one or more autonomous pentesting operations (e.g., verifying exploits), or any combination thereof.

The details 655 may indicate identification of an emerging vulnerability at 665 with an associated risk score 670-a of 5.4 (e.g., an initial risk score), identification of a vulnerability in a network at 675 with an associated confidence score 680-a of 90, re-assessment of risk at 665 associated with an updated risk score 670-b of 7.8 (e.g., based on the context of the vulnerability in the given network), verification of an exploit at 685 associated with an updated confidence score 680-b of 100 (e.g., verifying the presence of an exploit indicates that the network predicted to have the vulnerability indeed has the vulnerability), generation of a patch at 690 (e.g., a remediation operation), and application of the patch at 695.

In some examples, the dynamic dashboard 605 may include trend analysis and historical vulnerability insights. For example, the dynamic dashboard 605 may include time to remediation trends. That is, the dynamic dashboard 605 may display an indication of, over time, how long network assets were vulnerable before vulnerabilities were mitigated. As another example, the dynamic dashboard 605 may include trends around particular software and services, such as trends around Microsoft. Microsoft may trend more frequently than other vendors but have lower exploitability rates based on complexity and size of vulnerabilities. The dynamic dashboard 605 may display trends related to vulnerabilities themselves, timelines (e.g., when a vulnerability was identified, remediated, etc.), vulnerability information associated with network assets (e.g., indicating a network asset has high rates of vulnerabilities compared to other network assets based on use of anomaly detection), or the like. In some examples, the information included on the dynamic dashboard 605 may be based on information about a network, including products or services used by devices in the network.

In addition to or alternatively from the dynamic dashboard 605, the autonomous pentesting system may support transmission of alerts that indicate emerging vulnerabilities. For example, if a vulnerability is confirmed to be exploitable, the autonomous pentesting service may transmit an automated alert to affected users with detailed reports. Alerts may include vulnerability details, affected assets, confidence scores, and recommended remediation steps. Put another way, the autonomous pentesting service may selectively transmit a notification of an emerging vulnerability to one or more users associated with one or more network devices potentially having the emerging vulnerability based on the one or more confidence scores satisfying a threshold, the notification including an indication of the emerging vulnerability, the one or more confidence scores, one or more recommended remediation operations, or any combination thereof.

In some examples, the alerts may be based on confidence scores. For example, a vulnerability with a relatively high confidence score (e.g., above a threshold) may be alerted to a user for immediate action, whereas a vulnerability with a relatively lower confidence score (e.g., below a threshold) may be available on the dynamic dashboard 605 (but not sent out for customer action). The dynamic dashboard 605, the alerting, or both may enable users to take immediate action to address emerging vulnerabilities based on confidence-based alerting rather than waiting for manual verification steps.

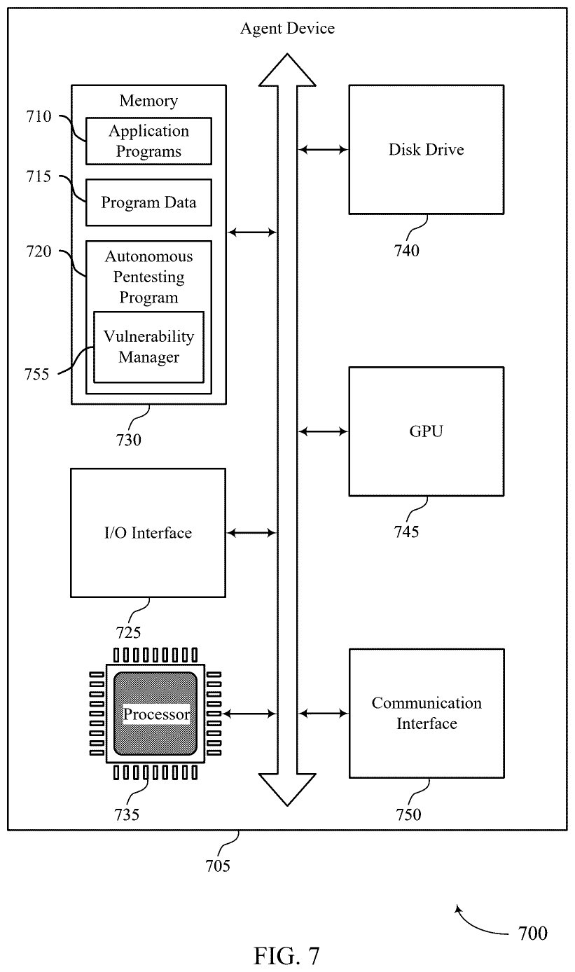

FIG. 7 shows a diagram of a system 700 including an agent device 705 that supports automated vulnerability integration, prioritization, and verification in autonomous pentesting in accordance with aspects of the present disclosure. The agent device 705 may be an example of a device or server on which an autonomous pentesting agent 105 is deployed as described herein. The agent device 705 may include components for automated vulnerability integration, prioritization, and verification in autonomous pentesting, such as a memory 730 including application programs 710, program data 715, an autonomous pentesting program 720, and a vulnerability manager 755; an input/output (I/O) interface 725; a processor 735; a disk drive 740; a graphics processing unit (GPU) 745; and a communication interface 750. Each of these components may communicate, directly or indirectly, with one another (e.g., via one or more buses, communications links, communications interfaces, or any combination thereof).

The I/O interface 725 may support connection of the agent device 705 with one or more other devices. For example, the agent device 705 may connect to keyboards, mice, printers, hard disks, or the like via the I/O interface 725. The I/O interface 725 may communicate with the processor 735. That is, the processor 735 may process signals from devices connected to the agent device 705 via the I/O interface 725.

Memory 730 may include RAM, ROM, or both. The memory 730 may store computer-readable, computer-executable software including instructions that, when executed, cause at least one processor 735 to perform various functions described herein, such as functions supporting automated vulnerability integration, prioritization, and verification in autonomous pentesting. In some cases, the memory 730 may contain, among other things, a basic input/output system (BIOS), which may control basic hardware or software operation such as the interaction with peripheral components or devices. The memory 730 may be an example of a single memory or multiple memories. For example, the agent device 705 may include one or more memories 730.

The application programs 710 in the memory 730 may be examples of app(s) 140 as described with reference to FIG. 1. For example, the application programs 710 may be installed on the memory 730 of the agent device 705, among other devices in a network. The application programs 710 may be examples of software applications or computer programs that are implemented to carry out one or more functions or tasks.

The program data 715 may be data related to the application programs 710. Program data 715 may be an example of or refer to running data of programs and applications installed on the memory 730 of the agent device 705. In some examples, the program data 715 may include various data, including code that allows the application programs 710 to perform the one or more functions or tasks.

The processor 735 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 735 may be configured to execute computer-readable instructions stored in at least one memory 730 to perform various functions (e.g., functions or tasks supporting automated vulnerability integration, prioritization, and verification in autonomous pentesting). Though a single processor 735 is depicted in the example of FIG. 7, it is to be understood that the system 700 may include any quantity of one or more of processors 735 and that a group of processors 735 may collectively perform one or more functions ascribed herein to a processor, such as the processor 735. The processor 735 may be an example of a single processor or multiple processors. For example, the agent device 705 may include one or more processors 735.

The disk drive 740 may be configured to store data that is generated, processed, stored, or otherwise used by the system 700. In some cases, the disk drive 740 may include one or more hard disk drives (HDDs), one or more solid-state drives (SSDs), or both. In some examples, the disk drive 740 may be an example of a single database, a distributed database, multiple distributed databases, a data store, a data lake, or an emergency backup database. In some examples, the disk drive 740 may be an example of one or more components described with reference to FIG. 1.

GPU 745 may be configured to store graphics-related data. The GPU 745 may store and manage data related to graphics and video processing. In some examples, the GPU 745 may be an example of or a component of a graphics card. The GPU 745 may use components of the memory 730, including the RAM, for temporary storage. For example, the GPU 745 may move data from the RAM of the memory 730 to the GPU 745 for graphics and video processing.

The communication interface 750 may enable the agent device 705 to exchange information (e.g., input information, output information, or both) with other systems or devices (not shown). For example, the communication interface 750 may enable the agent device 705 to connect to a network (e.g., a network 110 as described herein). The communication interface 750 may include one or more wireless network interfaces, one or more wired network interfaces, or any combination thereof.

The autonomous pentesting program 720 may be an example of a program of an autonomous pentesting service that is installed on the memory 730 of the agent device 705. The autonomous pentesting program 720 may execute an autonomous pentest of a network accessed by the agent device 705, such as accessed via the communication interface 750. That is, the autonomous pentesting program 720 may be configured to perform an autonomous pentest as described herein, including an autonomous pentest involving integrating emerging vulnerabilities with autonomous pentesting.

The vulnerability manager 755 may support integrating emerging vulnerabilities with autonomous pentesting in accordance with examples as disclosed herein. For example, the vulnerability manager 755 may be configured as or otherwise support a means for performing one or more first autonomous pentesting operations, the one or more first autonomous pentesting operations comprising collecting and storing network asset data of one or more networks. The vulnerability manager 755 may be configured as or otherwise support a means for receiving an indication of an emerging vulnerability applicable to an application or a service.

The vulnerability manager 755 may be configured as or otherwise support a means for identifying one or more network devices of the one or more networks associated with the application or the service based at least in part on the stored network asset data and receiving the indication of the emerging vulnerability. The vulnerability manager 755 may be configured as or otherwise support a means for generating one or more confidence scores associated with an accuracy of identifying of the one or more network devices based at least in part on a comparison between one or more first attributes of the application or the service associated with the one or more network devices and one or more second attributes of the emerging vulnerability. The vulnerability manager 755 may be configured as or otherwise support a means for selectively performing, in accordance with the one or more confidence scores, one or more second autonomous pentesting operations targeting the one or more network devices.

By including or configuring the vulnerability manager 755 in accordance with examples as described herein, the agent device 705 may support techniques for improved network security.

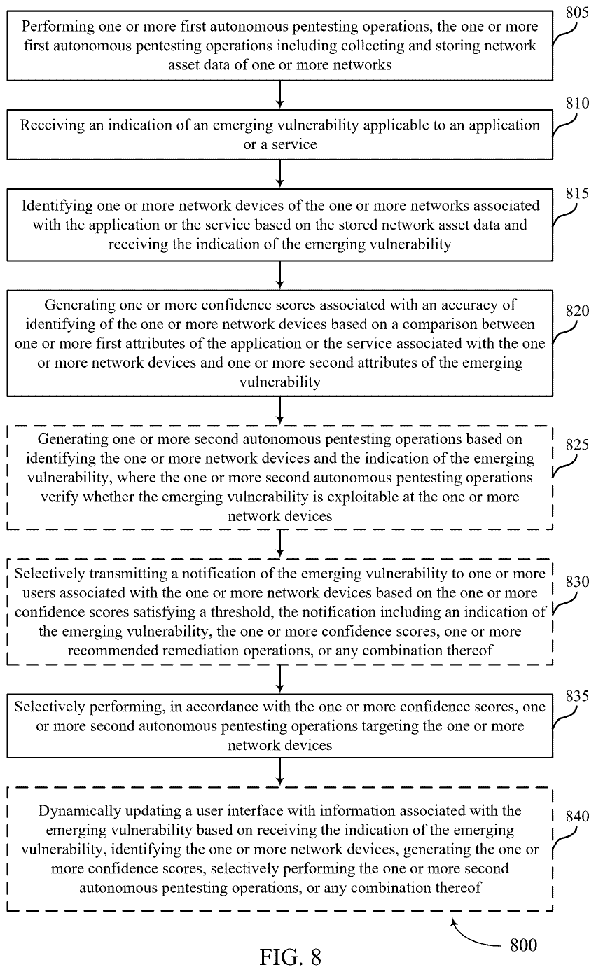

FIG. 8 shows a flowchart illustrating a method 800 that supports automated vulnerability integration, prioritization, and verification in autonomous pentesting in accordance with aspects of the present disclosure. The operations of the method 800 may be implemented by an agent device 705 or its components as described herein. In some examples, an agent device may execute a set of instructions to control the functional elements of the agent device to perform the described functions. Additionally, or alternatively, the agent device may perform aspects of the described functions using special-purpose hardware.

At 805, the method 800 may include performing one or more first autonomous pentesting operations, the one or more first autonomous pentesting operations including collecting and storing network asset data of one or more networks.

At 810, the method 800 may include receiving an indication of an emerging vulnerability applicable to an application or a service.

At 815, the method 800 may include identifying one or more network devices of the one or more networks associated with the application or the service based on the stored network asset data and receiving the indication of the emerging vulnerability.

At 820, the method 800 may include generating one or more confidence scores associated with an accuracy of identifying of the one or more network devices based on a comparison between one or more first attributes of the application or the service associated with the one or more network devices and one or more second attributes of the emerging vulnerability.

At 825, the method 800 may include generating the one or more second autonomous pentesting operations based on identifying the one or more network devices and the indication of the emerging vulnerability, where the one or more second autonomous pentesting operations verify whether the emerging vulnerability is exploitable at the one or more network devices.

At 830, the method 800 may include selectively transmitting a notification of the emerging vulnerability to one or more users associated with the one or more network devices based on the one or more confidence scores satisfying a threshold, the notification including an indication of the emerging vulnerability, the one or more confidence scores, one or more recommended remediation operations, or any combination thereof.

At 835, the method 800 may include selectively performing, in accordance with the one or more confidence scores, one or more second autonomous pentesting operations targeting the one or more network devices.

At 840, the method 800 may include dynamically updating a user interface with information associated with the emerging vulnerability based on receiving the indication of the emerging vulnerability, identifying the one or more network devices, generating the one or more confidence scores, selectively performing the one or more second autonomous pentesting operations, or any combination thereof.

Aspect 1: A method for integrating emerging vulnerabilities with autonomous pentesting, comprising: performing one or more first autonomous pentesting operations, the one or more first autonomous pentesting operations comprising collecting and storing network asset data of one or more networks; receiving an indication of an emerging vulnerability applicable to an application or a service; identifying one or more network devices of the one or more networks associated with the application or the service based at least in part on the stored network asset data and receiving the indication of the emerging vulnerability; generating one or more confidence scores associated with an accuracy of identifying of the one or more network devices based at least in part on a comparison between one or more first attributes of the application or the service associated with the one or more network devices and one or more second attributes of the emerging vulnerability; and selectively performing, in accordance with the one or more confidence scores, one or more second autonomous pentesting operations targeting the one or more network devices.

Aspect 2: The method of aspect 1, further comprising: selectively transmitting a notification of the emerging vulnerability to one or more users associated with the one or more network devices based at least in part on the one or more confidence scores satisfying a threshold, the notification comprising an indication of the emerging vulnerability, the one or more confidence scores, one or more recommended remediation operations, or any combination thereof.

Aspect 3: The method of aspect 2, further comprising: storing information associated with the one or more recommended remediation operations, wherein one or more third autonomous pentesting operations are selectively executed in accordance with a second emerging vulnerability and after the one or more second autonomous pentesting operations based at least in part on the stored information associated with the one or more recommended remediation operations.

Aspect 4: The method of aspect 2, further comprising: verifying implementation of the one or more recommended remediation operations via the one or more second autonomous pentesting operations.

Aspect 5: The method of any of aspects 1 through 4, further comprising: generating the one or more second autonomous pentesting operations based at least in part on identifying the one or more network devices and the indication of the emerging vulnerability, wherein the one or more second autonomous pentesting operations verify whether the emerging vulnerability is exploitable at the one or more network devices.

Aspect 6: The method of aspect 5, further comprising: receiving, prior to selectively executing the one or more second autonomous pentesting operations, a user input authorizing performing the one or more second autonomous pentesting operations.

Aspect 7: The method of any of aspects 1 through 6, further comprising: dynamically updating a user interface with information associated with the emerging vulnerability based at least in part on receiving the indication of the emerging vulnerability, identifying the one or more network devices, generating the one or more confidence scores, selectively performing the one or more second autonomous pentesting operations, or any combination thereof.

Aspect 8: The method of any of aspects 1 through 7, further comprising: generating one or more risk levels of exposure of the one or more network devices to the emerging vulnerability based at least in part on an attack probability, a quantity or priority level of the one or more network devices, a projected impact of compromise on the one or more network devices, or any combination thereof, wherein selectively performing the one or more second autonomous pentesting operations is further in accordance with the one or more risk levels.

Aspect 9: The method of any of aspects 1 through 8, further comprising: receiving an input to assign emerging vulnerabilities applicable to externally-facing network assets a higher risk level than emerging vulnerabilities applicable to internally-facing network assets, wherein selectively performing the one or more second autonomous pentesting operations is further in accordance with a risk level of the emerging vulnerability.

Aspect 10: The method of any of aspects 1 through 9, further comprising: generating, prior to identifying the one or more network devices, a risk score associated with the emerging vulnerability based at least in part on the one or more second attributes; and updating, after identifying the one or more network devices, the risk score based at least in part on the one or more first attributes of the one or more network devices.

Aspect 11: The method of any of aspects 1 through 10, further comprising: generating one or more queries for the stored network asset data based at least in part on the one or more second attributes of the emerging vulnerability, wherein the one or more network devices are identified based at least in part on the stored network asset data and using the one or more generated queries.

Aspect 12: The method of any of aspects 1 through 11, further comprising: augmenting first information associated with the emerging vulnerability received via the indication with second information, wherein the one or more second attributes of the emerging vulnerability are based at least in part on the first information and the second information.

Aspect 13: The method of any of aspects 1 through 12, wherein the indication of the emerging vulnerability is received from one or more information sources, the one or more information sources comprising one or more threat intelligence feeds, one or more vulnerability databases, one or more internal security logs, or any combination thereof.

Aspect 14: The method of any of aspects 1 through 13, wherein identifying the one or more network devices of the one or more networks comprises: receiving, from an LLM, an indication of the one or more network devices based at least in part on the stored network asset data, wherein the LLM is trained via one or more vulnerabilities and one or more remediation operations associated with the one or more vulnerabilities.

Aspect 15: The method of any of aspects 1 through 14, wherein generating the one or more confidence scores comprises: receiving, from an LLM, an indication of the one or more confidence scores based at least in part on the stored network asset data, wherein the LLM is trained via one or more vulnerabilities and one or more remediation operations associated with the one or more vulnerabilities.

Aspect 16: An apparatus for integrating emerging vulnerabilities with autonomous pentesting, comprising: one or more memories storing processor-executable code; and one or more processors coupled with the one or more memories and individually or collectively operable to execute the code to cause the apparatus to perform a method of any of aspects 1 through 15.

Aspect 17: A non-transitory computer-readable medium storing code for integrating emerging vulnerabilities with autonomous pentesting, the code comprising instructions executable by one or more processors to perform a method of any of aspects 1 through 15.

Aspect 18: An apparatus for integrating emerging vulnerabilities with autonomous pentesting, comprising at least one means for performing a method of any aspects 1 through 15.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for integrating emerging vulnerabilities with autonomous pentesting, comprising:
performing one or more first autonomous pentesting operations, the one or more first autonomous pentesting operations comprising collecting and storing network asset data of one or more networks;
receiving an indication of an emerging vulnerability applicable to an application or a service;
identifying one or more network devices of the one or more networks associated with the application or the service based at least in part on the stored network asset data and receiving the indication of the emerging vulnerability;
generating one or more confidence scores associated with an accuracy of identifying of the one or more network devices based at least in part on a comparison between one or more first attributes of the application or the service associated with the one or more network devices and one or more second attributes of the emerging vulnerability; and
selectively performing, in accordance with the one or more confidence scores, one or more second autonomous pentesting operations targeting the one or more network devices.

2. The method of claim 1, further comprising:
selectively transmitting a notification of the emerging vulnerability to one or more users associated with the one or more network devices based at least in part on the one or more confidence scores satisfying a threshold, the notification comprising an indication of the emerging vulnerability, the one or more confidence scores, one or more recommended remediation operations, or any combination thereof.

3. The method of claim 2, further comprising:
storing information associated with the one or more recommended remediation operations, wherein one or more third autonomous pentesting operations are selectively executed in accordance with a second emerging vulnerability and after the one or more second autonomous pentesting operations based at least in part on the stored information associated with the one or more recommended remediation operations.

4. The method of claim 2, further comprising:
verifying implementation of the one or more recommended remediation operations via the one or more second autonomous pentesting operations.

5. The method of claim 1, further comprising:
generating the one or more second autonomous pentesting operations based at least in part on identifying the one or more network devices and the indication of the emerging vulnerability, wherein the one or more second autonomous pentesting operations verify whether the emerging vulnerability is exploitable at the one or more network devices.

6. The method of claim 5, further comprising:
receiving, prior to selectively executing the one or more second autonomous pentesting operations, a user input authorizing performing the one or more second autonomous pentesting operations.

7. The method of claim 1, further comprising:
dynamically updating a user interface with information associated with the emerging vulnerability based at least in part on receiving the indication of the emerging vulnerability, identifying the one or more network devices, generating the one or more confidence scores, selectively performing the one or more second autonomous pentesting operations, or any combination thereof.

8. The method of claim 1, further comprising:
generating one or more risk levels of exposure of the one or more network devices to the emerging vulnerability based at least in part on an attack probability, a quantity or priority level of the one or more network devices, a projected impact of compromise on the one or more network devices, or any combination thereof, wherein selectively performing the one or more second autonomous pentesting operations is further in accordance with the one or more risk levels.

9. The method of claim 1, further comprising:
receiving an input to assign emerging vulnerabilities applicable to externally-facing network assets a higher risk level than emerging vulnerabilities applicable to internally-facing network assets, wherein selectively performing the one or more second autonomous pentesting operations is further in accordance with a risk level of the emerging vulnerability.

10. The method of claim 1, further comprising:
generating, prior to identifying the one or more network devices, a risk score associated with the emerging vulnerability based at least in part on the one or more second attributes; and
updating, after identifying the one or more network devices, the risk score based at least in part on the one or more first attributes of the one or more network devices.

11. The method of claim 1, further comprising:
generating one or more queries for the stored network asset data based at least in part on the one or more second attributes of the emerging vulnerability, wherein the one or more network devices are identified based at least in part on the stored network asset data and using the one or more generated queries.

12. The method of claim 1, further comprising:
augmenting first information associated with the emerging vulnerability received via the indication with second information, wherein the one or more second attributes of the emerging vulnerability are based at least in part on the first information and the second information.

13. The method of claim 1, wherein the indication of the emerging vulnerability is received from one or more information sources, the one or more information sources comprising one or more threat intelligence feeds, one or more vulnerability databases, one or more internal security logs, or any combination thereof.

14. The method of claim 1, wherein identifying the one or more network devices of the one or more networks comprises:
receiving, from a large language model (LLM), an indication of the one or more network devices based at least in part on the stored network asset data, wherein the LLM is trained via one or more vulnerabilities and one or more remediation operations associated with the one or more vulnerabilities.

15. The method of claim 1, wherein generating the one or more confidence scores comprises:
receiving, from a large language model (LLM), an indication of the one or more confidence scores based at least in part on the stored network asset data, wherein the LLM is trained via one or more vulnerabilities and one or more remediation operations associated with the one or more vulnerabilities.

16. An apparatus for integrating emerging vulnerabilities with autonomous pentesting, comprising:
one or more memories storing processor-executable code; and
one or more processors coupled with the one or more memories and individually or collectively operable to execute the code to cause the apparatus to:
perform one or more first autonomous pentesting operations, the one or more first autonomous pentesting operations comprising collecting and storing network asset data of one or more networks;
receive an indication of an emerging vulnerability applicable to an application or a service;
identify one or more network devices of the one or more networks associated with the application or the service based at least in part on the stored network asset data and receiving the indication of the emerging vulnerability;
generate one or more confidence scores associated with an accuracy of identifying of the one or more network devices based at least in part on a comparison between one or more first attributes of the application or the service associated with the one or more network devices and one or more second attributes of the emerging vulnerability; and
selectively perform, in accordance with the one or more confidence scores, one or more second autonomous pentesting operations targeting the one or more network devices.

17. The apparatus of claim 16, wherein the one or more processors are individually or collectively further operable to execute the code the cause the apparatus to:
selectively transmit a notification of the emerging vulnerability to one or more users associated with the one or more network devices based at least in part on the one or more confidence scores satisfying a threshold, the notification comprising an indication of the emerging vulnerability, the one or more confidence scores, one or more recommended remediation operations, or any combination thereof.

18. The apparatus of claim 16, wherein the one or more processors are individually or collectively further operable to execute the code the cause the apparatus to:
generate the one or more second autonomous pentesting operations based at least in part on identifying the one or more network devices and the indication of the emerging vulnerability, wherein the one or more second autonomous pentesting operations verify whether the emerging vulnerability is exploitable at the one or more network devices.

19. A non-transitory computer-readable medium storing code for integrating emerging vulnerabilities with autonomous pentesting, the code comprising instructions executable by one or more processors to:
perform one or more first autonomous pentesting operations, the one or more first autonomous pentesting operations comprising collecting and storing network asset data of one or more networks;
receive an indication of an emerging vulnerability applicable to an application or a service;
identify one or more network devices of the one or more networks associated with the application or the service based at least in part on the stored network asset data and receiving the indication of the emerging vulnerability;
generate one or more confidence scores associated with an accuracy of identifying of the one or more network devices based at least in part on a comparison between one or more first attributes of the application or the service associated with the one or more network devices and one or more second attributes of the emerging vulnerability; and
selectively perform, in accordance with the one or more confidence scores, one or more second autonomous pentesting operations targeting the one or more network devices.

20. The non-transitory computer-readable medium of claim 19, wherein the instructions are further executable by the one or more processors to:
selectively transmit a notification of the emerging vulnerability to one or more users associated with the one or more network devices based at least in part on the one or more confidence scores satisfying a threshold, the notification comprising an indication of the emerging vulnerability, the one or more confidence scores, one or more recommended remediation operations, or any combination thereof.
